(19) United States
(12) Patent Application Publication
(10) Pub. No.: US 2017/0258056 A1
(43) Pub. Date: Sep. 14, 2017

(54) AQUARIUM ORNAMENTAL DEVICE

(71) Applicant: Northern Sky Ventures Limited, Hong Kong (HK)

(72) Inventor: Michael Brown, Ottawa (CA)

(21) Appl. No.: 15/456,612

(22) Filed: Mar. 13, 2017

(30) Foreign Application Priority Data
Mar. 11, 2016 (CN) 201620191612.8

(51) Int. Cl. A01K 63/00; F04B 53/10

(52) U.S. Cl. CPC A01K 63/006; F04B 53/10

(57) ABSTRACT

Disclosed is an aquarium ornamental device. An aquarium ornamental device comprises a compressor configured for compressing inlet air, a multiport valve that is electromechanical or mechanically actuated, a plurality of pipes, and an expandable-and-shrinkable member having at least one one-way valve; the compressor, the multiport valve, and the expandable-and-shrinkable member are connected one another in sequence by means of the pipes; the compressor and the multiport valve are placed outside the aquarium, and the expandable-and-shrinkable member having the one-way valve is placed in the water contained within the aquarium.

### CROSS REFERENCE TO RELATED APPLICATIONS

The present application claims the benefit of Chinese Utility Model Application No. 201620191612.8 filed on Mar. 11, 2016. All the above are hereby incorporated by reference.

### TECHNICAL FIELD

The present invention relates to an ornament for an aquarium, especially to an expandable-and-shrinkable aquarium ornamental device.

### BACKGROUND OF THE INVENTION

Currently, for the purpose of increasing the aesthetic appeal of aquariums, there are ornaments such as fake rocks, miniature architectural ruins, aquatic plants and so on provided for decoration. However, such ornaments are normally static, dull in structure and lack variation in viewing effect, thus failing to meet different demands of viewers.

### SUMMARY OF THE INVENTION

In order to overcome the disadvantages of the prior art, the present invention provides an aquarium ornamental device. The aquarium ornamental device comprises: a compressor for compressing an inlet air, a multiport valve that is electromechanical or mechanically actuated, a plurality of pipes, and an expandable-and-shrinkable member having at least one one-way valve; wherein the compressor, the multiport valve, and the expandable-and-shrinkable member are connected to one another in sequence by means of the pipes; wherein the compressor and the multiport valve are placed outside the aquarium, and the expandable-and-shrinkable member having the one-way valve is placed in the water contained within the aquarium.

In some embodiments, the pipe between the multiport valve and the compressor is provided with a flow valve to control the flow rate of air into the expandable-and-shrinkable member.

In some embodiments, the expandable-and-shrinkable member comprises a body part which is expandable and shrinkable and made of inflatable material that is elastic or inelastic, and a base part attached to the body part and having an air inlet, the air inlet of the base part is connected with the pipe for introducing air.

In some embodiments, the expandable-and-shrinkable member is configured to control the buoyancy of the expandable-and-shrinkable member.

In some embodiments, the base part of the expandable-and-shrinkable member is in the form of a cavity or other suitable geometry so as to fully accommodate the body part of the expandable-and-shrinkable member or act on only a portion of the body part, when the body part is shrunk.

In some embodiments, the body part of the expandable-and-shrinkable member is provided with the one-way valve so as to allow air of a sufficient pressure to escape the expandable-and-shrinkable member, but not to allow the flow of water in the aquarium into the expandable-and-shrinkable member.

Alternatively, the base part of the expandable-and-shrinkable member is provided with the one-way valve so as to allow air of a sufficient pressure to escape the expandable-and-shrinkable member, but not to allow the flow of water in the aquarium into the expandable-and-shrinkable member.

Alternatively, the body part and the base part are both provided with the one-way valve so as to allow air of a sufficient pressure to escape the expandable-and-shrinkable member, but not to allow the flow of water in the aquarium into the expandable-and-shrinkable member.

In some embodiments, the air inlet of the base part of the expandable-and-shrinkable member is connected with the pipe provided with a one-way valve oriented so as to allow air of a sufficient pressure to escape the expandable-and-shrinkable member, but not to allow the flow of water in the aquarium into the expandable-and-shrinkable member.

In some embodiments, the position of the multiport valve is higher than the water level in the aquarium.

In some embodiments, the multiport valve is connected with any one or a combination selected from the group consisting of a sonic, a programmable logic controller, a custom control circuit, a switch, an optical sensor, a radio device and a Bluetooth device.

Furthermore, the multiport valve has a variety of ports having different diameters and path lengths so as to produce varying speeds and sounds as the expandable-and-shrinkable member collapses or shrinks.

In some embodiments, the body part and/or the base part of the expandable-and-shrinkable member is transparent or translucent to allow for lighting effects from an embedded or under-aquarium light source.

In some embodiments, the aquarium ornamental device further comprises a motion-enabled device via the expandable-and-shrinkable member, the expandable-and-shrinkable member acts on some portions of the motion-enabled device or all of the motion-enabled device to produce various forms of motion for the motion-enabled device.

In some embodiments, the motion of the motion-enabled device is rotational motion or linear motion.

In some embodiments, the expandable-and-shrinkable member is used to affect the buoyancy of the motion-enabled device.

The expandable-and-shrinkable member is also self-purging able to expel any water resulting from leakage, condensation, or inadvertent submersion during installation or maintenance, through its one-way valve during one or more expansion cycles.

The multiport valve is configured to, in one state, allow for the flow of air from the compressor to the expandable-and-shrinkable member. When switched to another state, the flow of air from the compressor will be blocked and a breather port of the multiport valve will now be open to atmosphere, thereby establishing an air path from the expandable-and-shrinkable member to the atmosphere and allowing the body part to evacuate its air and be shrunk due to the hydrostatic pressure acting against it. Any water expelled from the expandable-and-shrinkable member back through the air path is directed back into the aquarium.

The position of the multiport valve is higher than the water level in the aquarium so as to ensure that the breather port is always located above the water level of the aquarium in order that the air path from the expandable-and-shrinkable member to atmosphere, essential for its operation, always exists; that any water in the body part resulting from leakage, condensation, or submersion during initial installation, that is being forced back up the air path from the body part collapsing, is purged through the breather port and directly back into the aquarium; and water cannot drain from the aquarium through the air path due to syphoning. Locating the breather port (path to atmospheric pressure) just before the air path runs over and down the aquarium wall to the compressor ensures that the syphon effect cannot be initiated by gravity.

### BRIEF DESCRIPTION OF THE INVENTION

For a better understanding of the aforementioned embodiments of the invention as well as additional embodiments thereof, reference should be made to the Description of Embodiments below, in conjunction with the following drawings in which like reference numerals refer to corresponding parts throughout the figures.

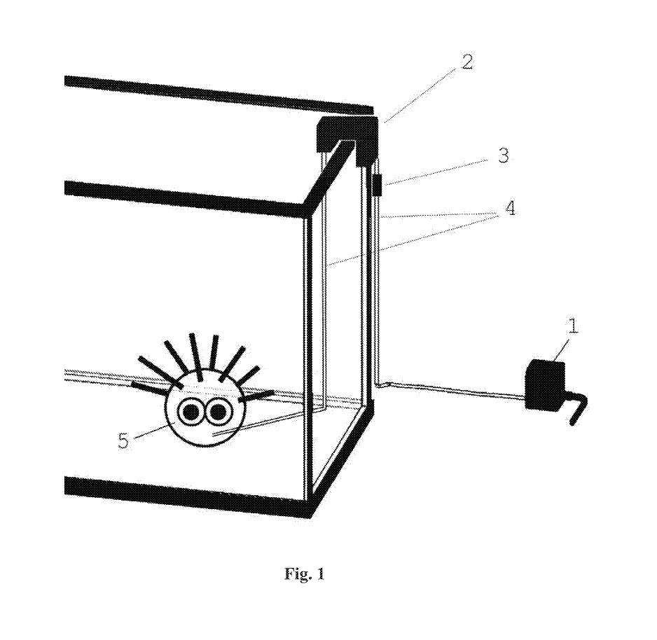

FIG. 1 is a schematic diagram of an aquarium ornamental device according to some embodiments of the present invention.

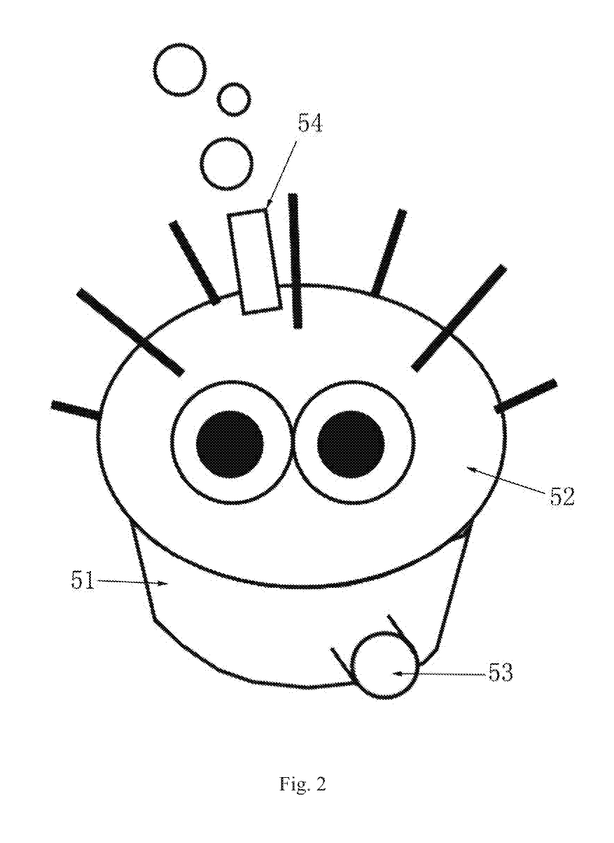

FIG. 2 is a schematic diagram of an expandable-and-shrinkable member according to some embodiments of the present invention.

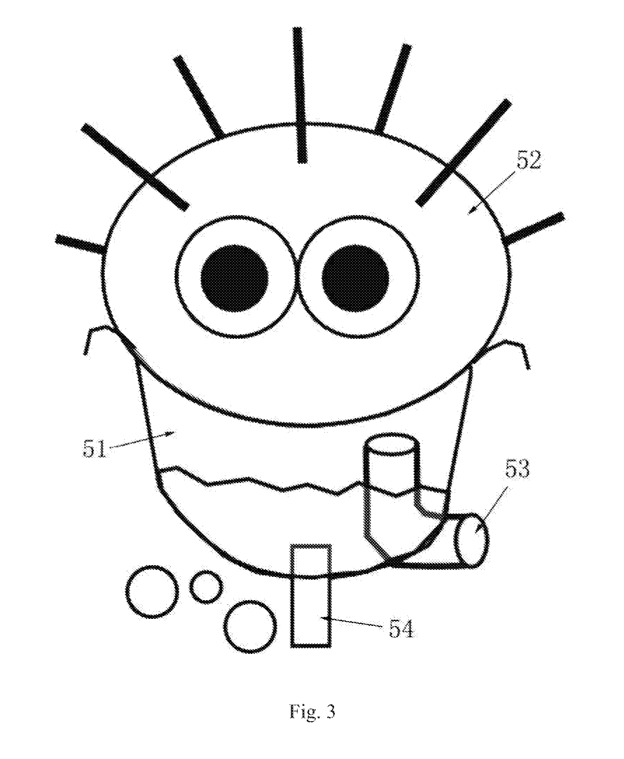

FIG. 3 is a schematic diagram of an expandable-and-shrinkable member according to some embodiments of the present invention.

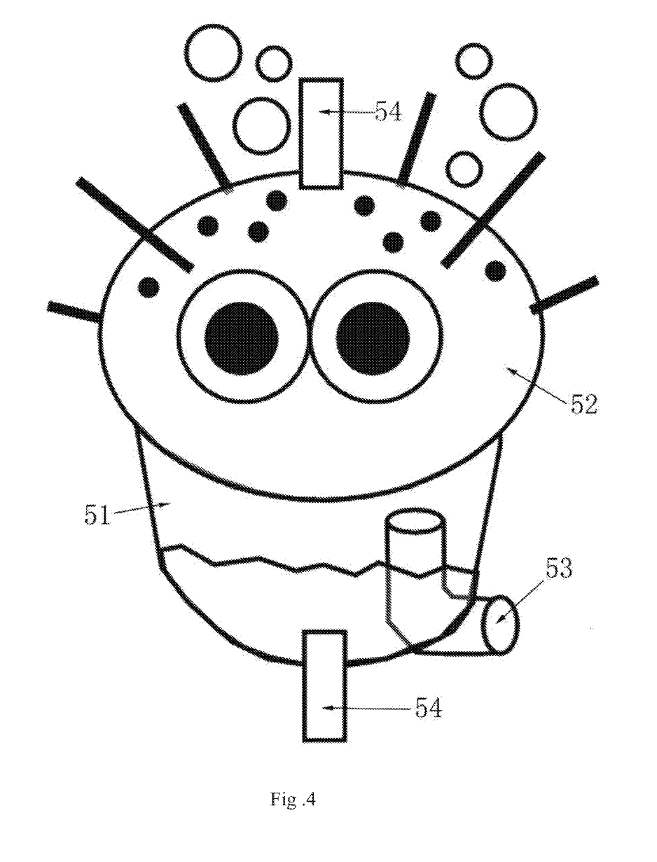

FIG. 4 is a schematic diagram of an expandable-and-shrinkable member according to some embodiments of the present invention.

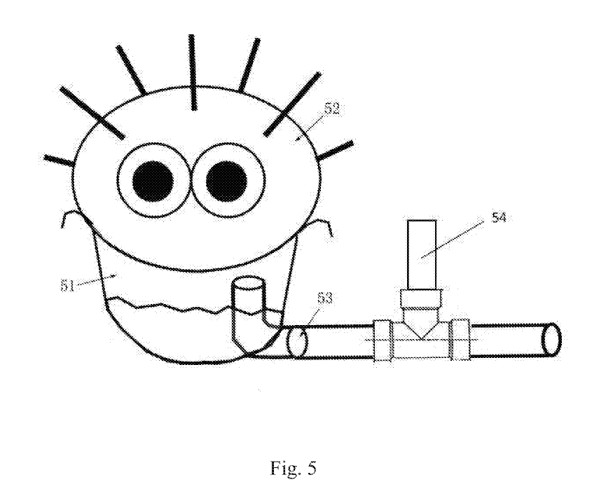

FIG. 5 is a schematic diagram of an expandable-and-shrinkable member according to some embodiments of the present invention.

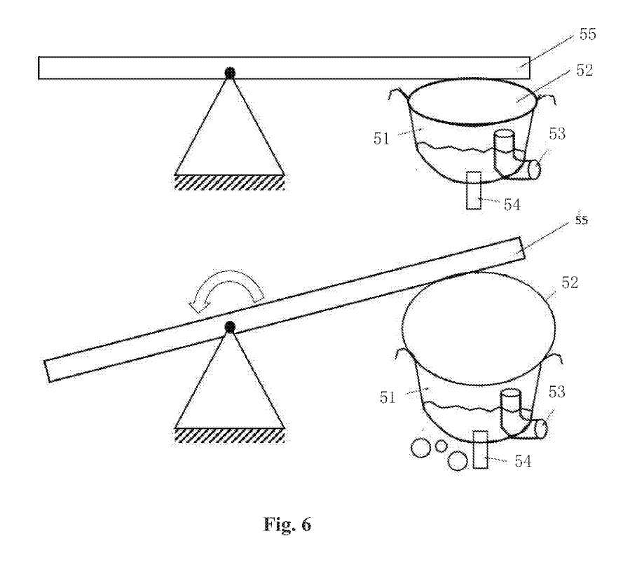

FIG. 6 is a schematic diagram of an expandable-and-shrinkable member acting against a motion-enabled device which is rotationally constrained, thereby providing rotational motion for the motion-enabled device.

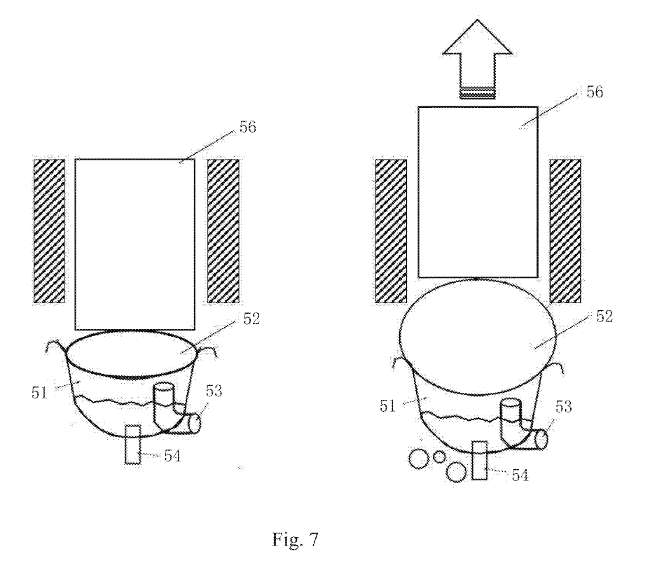

FIG. 7 is a schematic diagram of an expandable-and-shrinkable member acting against a motion-enabled device which is linearly constrained, thereby providing linear motion for the motion-enabled device.

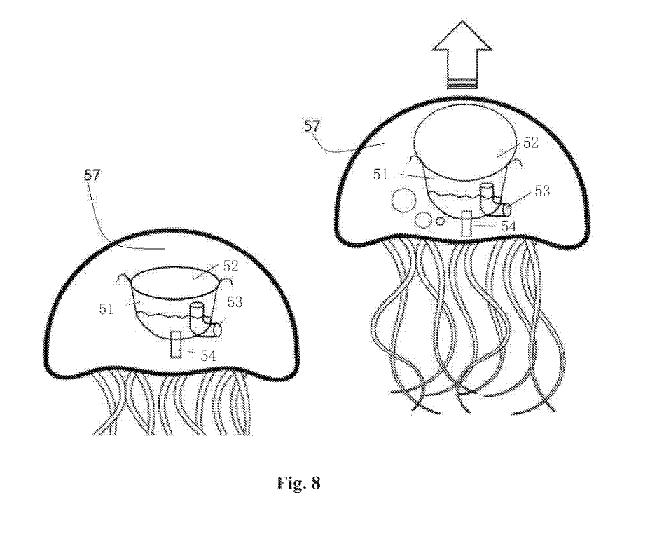

FIG. 8 is a schematic diagram of an expandable-and-shrinkable member embedded within a motion-enabled device for altering the buoyancy of the motion-enabled device.

### DESCRIPTION OF THE INVENTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known components and circuits have not been described in detail so as not to unnecessarily obscure aspects of the embodiments.

FIG. 1 illustrates an aquarium ornamental device according to some embodiments of the present invention. The aquarium ornamental device comprising: a compressor 1 for compressing an inlet air, a multiport valve 2 that is electromechanical or mechanically actuated, a plurality of pipes 4, and an expandable-and-shrinkable member 5 having at least one one-way valve; wherein the compressor 1, the multiport valve 2, and the expandable-and-shrinkable member 5 are connected one another in sequence by means of the pipes 4; wherein the compressor 1 and the multiport valve 2 are placed outside the aquarium, and the expandable-and-shrinkable member 5 having the one-way valve is placed in the water contained within the aquarium. Preferably, a plurality of expandable-and-shrinkable members may be operated together sharing a single multiport valve 2 and compressor 1. A flow-adjustable valve 3 or flow-fixed means 3 is arranged between the multiport valve 2 and the compressor 1 to control the flow rate of air into the expandable-shrinkable member 5.

In some embodiments, the multiport valve 2 is configured to, in one state, allow for the flow of air from the compressor 1 to the expandable-and-shrinkable member 5. When switched to another state, the flow of air from the compressor 1 will be blocked and a breather port of the multiport valve 2 will be open to atmosphere, thereby establishing an air path from the expandable-and-shrinkable member 5 to the atmosphere and allowing a body part 52 of the expandable-and-shrinkable member 5 (as shown in FIG. 2) to evacuate its air and be shrunk due to the hydrostatic pressure acting against it.

In some embodiments, the multiport valve has a variety of ports having different diameters and path lengths so as to produce varying speeds and sounds as the expandable-and-shrinkable member collapses or shrinks. Different effects may be achieved by selecting one of the ports with varying diameter and path length as the breather port. Small diameters and long path lengths result in slow shrinking and very quiet operation whereas larger diameters and shorter paths result in noisier operation and rapid shrinking. Valves with additional states (more ports) may allow for different effects as desired.

As shown in FIG. 1, the multiport valve 2 is positioned higher than the water level in the aquarium, so that the flow of water out of the aquarium by syphoning is prevented. Syphoning due to gravity is broken by opening the air path to atmospheric pressure through the breather port of the multiport valve 2 before the water in the air path can flow over the aquarium edge and downwards and inducing syphon by gravity.

Referring to FIG. 2, the expandable-and-shrinkable member 5 comprises a body part 52 which is expandable and shrinkable, and a base part 51 attached to the body part 52 and having an air inlet 53. The body part may 52 be made of inflatable material and the base part 51 may be in the form of a cavity, or other suitable geometry, so as to fully accommodate, or act on only a portion of the body part 52, to produce a desired effect when the body part 52 is shrunk. Furthermore, the body part 52 and the base part 51 are in fluid communication. In some embodiments, the air inlet 53 of the base part 52 may be connected to the pipe 4 for introducing the air from the compressor 1 to the expandable-and-shrinkable member 5. In this sense, the air from the compressor 1 can be charged into the body part 52 of the expandable-and-shrinkable member 5 through the air inlet 53 attached to the base part 51. As can be seen in FIG. 2, the expandable-and-shrinkable member 5 is urchin-shaped. However, any other suitable shapes may be employed, such as something that occurs in nature (e.g. anemone, urchin, eel, octopus, coral, etc.) or in imagination (e.g. a dragon, a cartoon character, etc.). Surely, it also could be something artificial, like vessel, aircraft the like.

Still referring to FIG. 2, a one-way valve 54 is provided at the body part 52 of the expandable-and-shrinkable member 5 so as to allow air of a sufficient pressure to escape the expandable-and-shrinkable member 5, but not to allow the flow of aquarium water into the expandable-and-shrinkable member 5. Alternatively, referring to FIG. 3, the one-way valve 54 is provided at the base part 51 of the expandable-and-shrinkable member 5. Further alternatively, in FIG. 4, two one-way valves are provided at the base part 51 and the body part 52, respectively. The one-way valve 54 serves as a pressure relief valve and thus prevents damage to the body part 52 from over inflation, simplifies the control system by eliminating the need to monitor the volume of air supplied to the body part 52 in order to avoid over inflation, and provides the added benefit of aeration to the aquarium water. Furthermore, the one-way valve 54 allows for the purging of any water resulting from leakage, or condensation, or initial submersion during installation, from the body part 52 of the expandable-and-shrinkable member 5. During an expansion cycle, the incoming air forces the water out through the one-way valve 54 and back into the aquarium.

Referring to FIG. 5, in some embodiments, the air inlet 53 of the base part 51 is connected with the pipe which is provided with a one-way valve 54 oriented so as to allow air of a sufficient pressure to escape the expandable-and-shrinkable member 5, but not to allow the flow of aquarium water into the expandable-and-shrinkable member 5.

The air enters the expandable-and-shrinkable member 5 via the plurality of pipes 4 from the multiport valve 2 and the flow-adjustable valve 3 or the flow-fixed means 3 after being compressed by the compressor 1. The pressurized air will cause the body part 52 to expand as the body part is made of inflatable material, countering the hydrostatic pressure acting against it due to being submersed in the aquarium water. The body part 52 will continue to expand until its internal pressure reaches the opening pressure of the one-way valve 54. At this time, any excess pressure is released from the body through the one-way valve 54 and the bubbling/aeration occurs. The multiport valve 2 is controlled by a circuit that actuates the multiport valve 2 between two or more states. In a first state, the multiport valve 2 directs air to the expandable-and-shrinkable member 5, causing the expansion of the body part 52 and eventually the bubbling. In a second state, the multiport valve 2 opens the air path from the expandable-and-shrinkable member 5 to atmosphere. At this time, the air in the body part 52 is expelled back up the air path and out to atmosphere due to the hydrostatic pressure of the water collapsing the body part 52. The body part 52 will be evacuated of air and collapse, or retract, under hydrostatic pressure, into the cavity or mating geometry provided by the base part 51.

In the embodiments respectively represented by FIGS. 2-4, different locations and numbers of the one-way valve 54 may be possible. In this case, different locations and numbers of the one-way valve 54 may make the expandable-and-shrinkable member 5 generate bubbles at different places with different amounts. Depending on the desired effect, any one of them or their combination may be adopted.

In the embodiments respectively represented by FIGS. 6-7 different forms of motion are derived from the expansion and shrinkage of the expandable-and-shrinkable member 5. FIG. 6 schematically represents the derivation of rotational motion of a motion-enabled device 55 whereas FIG. 7 represents linear motion of a motion-enabled device 56. In FIG. 6, the expandable-and-shrinkable member is acting against the motion-enabled device 55 which is rotationally constrained whereas the expandable-and-shrinkable of FIG. 7 is acting against the motion-enabled device 56 which is linearly constrained. FIG. 8 schematically illustrates how the expandable-and-shrinkable member 5 may alter the buoyancy of a motion-enabled device 57. As shown in FIG. 8, the motion-enabled device 57 is shaped as a jellyfish. However, any other suitable shapes may be adopted, such as something that occurs in nature (e.g. anemone, urchin, eel, octopus, coral, etc.) or in imagination (e.g. a dragon, a cartoon character, etc.). Surely, it also could be something artificial, like vessel, aircraft the like.

As shown in FIGS. 1-7, the expandable-and-shrinkable member 5 itself maybe an motion-enabled device. However, in FIG. 8, the expandable-and-shrinkable member 5 may be embedded within an motion-enabled device 57. The expandable-and-shrinkable member 5 is configured to act on some portion or all of the motion-enabled device by affecting the buoyancy of the motion-enabled device 57.

For purpose of making the inflation and shrinkage of the aquarium ornamental device more interesting, the multiport valve 2 may further be connected with one of a sonic sensor, a programmable logic controller (PLC), a custom control circuit, a switch, an optical sensor, a radio device or a Bluetooth device, or combinations thereof. In this way, under the control of the acoustic wave, predetermined program, physical switch, light, wireless or Bluetooth signal, the multiport valve 2 is capable of controlling the inflation and shrinkage of the expandable-and-shrinkable member 5 thus providing an interactive relationship between user and the ornamental device or allowing the unit to go to “sleep” in an unoccupied room.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilized the invention and various embodiments with various modifications as are suited to the particular use contemplated.

What is claimed is:

1. An aquarium ornamental device, comprising
a compressor configured for compressing inlet air,
a multiport valve that is electromechanical or mechanically actuated,
a plurality of pipes, and
an expandable-and-shrinkable member having at least one one-way valve;
wherein the compressor, the multiport valve, and the expandable-and-shrinkable member are connected one another in sequence by means of the pipes;
wherein the compressor and the multiport valve are placed outside the aquarium, and the expandable-and-shrinkable member having the one-way valve is placed in the water contained within the aquarium.

2. The aquarium ornamental device according to claim 1, wherein the pipe between the multiport valve and the compressor is provided with a flow-adjustable valve or a flow-fixed means to control the flow rate of air into the expandable-and-shrinkable member.

3. The aquarium ornamental device according to claim 1, wherein the expandable-and-shrinkable member comprises a body part which is expandable and shrinkable and made of inflatable material that is elastic or inelastic, and a base part attached to the body part and having an air inlet, the air inlet of the base part is connected with the pipe for introducing air.

4. The aquarium ornamental device according to claim 3, wherein the expandable-and-shrinkable member is configured to control the buoyancy of the expandable-and-shrinkable member.

5. The aquarium ornamental device according to claim 3, wherein the base part of the expandable-and-shrinkable member is in the form of a cavity or other suitable geometry so as to fully accommodate the body part of the expandable-and-shrinkable member or act on only a portion of the body part, when the body part is shrunk.

6. The aquarium ornamental device according to claim 3, wherein the body part of the expandable-and-shrinkable member is provided with the one-way valve so as to allow air of a sufficient pressure to escape the expandable-and-shrinkable member, but not to allow the flow of water in the aquarium into the expandable-and-shrinkable member.

7. The aquarium ornamental device according to claim 3, wherein the base part of the expandable-and-shrinkable member is provided with the one-way valve so as to allow air of a sufficient pressure to escape the expandable-and-shrinkable member, but not to allow the flow of water in the aquarium into the expandable-and-shrinkable member.

8. The aquarium ornamental device according to claim 3, wherein the body part and the base part are both provided with the one-way valve so as to allow air of a sufficient pressure to escape the expandable-and-shrinkable member, but not to allow the flow of water in the aquarium into the expandable-and-shrinkable member.

9. The aquarium ornamental device according to claim 3, wherein the air inlet of the base part of the expandable-and-shrinkable member is connected with the pipe provided with a one-way valve oriented so as to allow air of a sufficient pressure to escape the expandable-and-shrinkable member, but not to allow the flow of water in the aquarium into the expandable-and-shrinkable member.

10. The aquarium ornamental device according to claim 1, the position of the multiport valve is higher than the water level in the aquarium.

11. The aquarium ornamental device according to claim 1, wherein the multiport valve is connected with any one or a combination selected from the group consisting of a sonic, a programmable logic controller, a custom control circuit, a switch, an optical sensor, a radio device and a Bluetooth device.

12. The aquarium ornamental device according to claim 1, wherein the multiport valve has a variety of ports having different diameters and path lengths so as to produce varying speeds and sounds as the expandable-and-shrinkable member collapses or shrinks.

13. The aquarium ornamental device according to claim 3, wherein the body part and/or the base part of the expandable-and-shrinkable member is transparent or translucent to allow for lighting effects from an embedded or under-aquarium light source.

14. The aquarium ornamental device according to claim 1, wherein the aquarium ornamental device further comprises a motion-enabled device motioning via the expandable-and-shrinkable member, the expandable-and-shrinkable member acts on some portions of the motion-enabled device or all of the motion-enabled device to produce various forms of motion for the motion-enabled device.

15. The aquarium ornamental device according to claim 14, wherein the motion of the motion-enabled device is rotational motion or linear motion.

16. The aquarium ornamental device according to claim 14, wherein the expandable-and-shrinkable member is used to affect the buoyancy of the motion-enabled device.

17. The aquarium ornamental device according to claim 1, wherein the multiport valve is actuated between at least two states: in a first state, the multiport allows for the flow of air from the compressor to the expandable-and-shrinkable member; in a second state, the flow of air from the compressor is blocked and a breather port of the multiport valve is open to atmosphere, thereby establishing an air path from the expandable-and-shrinkable member to the atmosphere and allowing the body part to evacuate its air and be shrunk due to the hydrostatic pressure acting against it.

18. The aquarium ornamental device according to claim 17, wherein in the first state, the expandable-and-shrinkable member is self-purging able to expel the water resulting from leakage, condensation, or inadvertent submersion during installation or maintenance, through the one-way valve during one or more expansion cycles.

19. The aquarium ornamental device according to claim 17, wherein in the second state, the expandable-and-shrinkable is self-purging able to expel the water resulting from leakage, condensation, or inadvertent submersion during installation or maintenance, through the air path back into the aquarium.
